(19) United States
(12) Patent Application Publication
(10) Pub. No.: US 2006/0177017 A1
(43) Pub. Date: Aug. 10, 2006

(54) Device for converting voice to numeral

(75) Inventor: Takehiro Abeta, Anjo-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/340,195

(22) Filed: Jan. 26, 2006

(30) Foreign Application Priority Data
Feb. 8, 2005 (JP) 2005-032087

(51) Int. Cl. H04M 1/64

(52) U.S. Cl. 379/88.01

(57) ABSTRACT

A device for converting voices to numerals is applied to an on-board navigation system having a mobile phone operated hands-free. Voice signals inputted into the device are processed to specify a spelling of a word represented by the voice signals using a voice-spelling database stored in the device. A series of numerals (a telephone number) is specified from characters included in the specified spelling using a character-numeral database showing a correspondence between a group of a few characters and a one-digit numeral. The telephone number thus converted from the inputted voice signals is fed to the mobile phone to initiate a call.

### CROSS-REFERENCE TO RELATED APPLICATION

This application is based upon and claims benefit of priority of Japanese Patent Application No. 2005-32087 filed on Feb. 8, 2005, the content of which is incorporated herein by reference.

### BACKGROUND OF THE INVENTION

1. Field of the Invention

The present invention relates to a device that converts voices to numerals and to a computer program performing the conversion.

2. Description of Related Art

A device for specifying numerals, such as a telephone number, directly from voice data signals taken from utterance of a speaker has been known hitherto. Further, a device, in which a name of a facility is specified from a user's voice and a telephone number of that facility is specified based on a database showing correspondence between facilities and telephone numbers, is proposed in US 2003/0043976 A1. A user of the proposed device is able to call a particular facility by naming the facility without inputting a telephone number. However, in the proposed device, it is necessary to have a bulky database showing telephone numbers corresponding to names of facilities.

### SUMMARY OF THE INVENTION

The present invention has been made in view of the above-mentioned problem, and an object of the present invention is to provide a device for converting voices to numerals, such as telephone numbers, in which voices are converted to a series of numerals without using a bulky database showing correspondence between names and respective telephone numbers.

The device for converting voices to numerals according to the present invention is applicable to various apparatus such as a navigation system mounted on an automotive vehicle. The on-board navigation system includes a mobile phone with which a user communicates hands-free. The device for converting voices to numerals includes a voice data inputting circuit, a memory device storing a voice-spelling database and a character-numeral database, and an a microcomputer for carrying out a process of converting voices to numerals according to a computer program stored in the device.

A spelling of a word indicating a name of a facility or a place is specified from voice signals obtained from utterance of a user based on the voice-spelling database. Then, a series of numerals (a telephone number) is specified from characters included in the specified spelling based on the character-numeral database. The character-numeral database contains correspondence between a group of characters and a one-digit numeral in the same manner as in a push-button panel of a cell phone or a mobile phone. The specified series of numbers (a telephone number) is fed to the mobile phone to dial the number to initiate a call.

The device for converting voices to numerals may further include a voice-numeral database. Voice signals are converted to a series of numerals based on the voice-numeral database. Then, whether the converted numerals include a predetermined number such as a prefix number for a free-call telephone number is determined. If the predetermined number is included, voice signals representing a word such as a facility name, which are inputted following the predetermined number, are processed to specify a spelling of the word based on the voice-spelling database. Then, a series of numerals (a telephone number that follows the free-call prefix) is specified from the characters in the specified spelling based on the character-numeral database. Since the facilities offering a free-call are not too many, the spelling of the facility name is specified using the voice-spelling database having a reasonable size.

According to the present invention, a spelling of a word is specified from voice signals based on the voice-spelling database, and then, a series of numerals is specified from the characters included in the specified spelling based on the character-numeral database. Therefore, voice signals are converted into series of numerals without using a bulky database directly showing correspondence between words and a series of numerals. Other objects and features of the present invention will become more readily apparent from a better understanding of the preferred embodiment described below with reference to the following drawings.

### BRIEF DESCRIPTION OF THE DRAWINGS

FIG. 1 is a block diagram showing a navigation system mounted on an automotive vehicle;

FIG. 2 shows an external memory device storing various database;

FIG. 3 shows a part of a mobile phone having push buttons representing respective numerals and characters;

FIG. 4 is a flowchart showing a process of converting voices to numerals; and

FIG. 5 is a flowchart showing a process of specifying numerals from voices.

### DETAILED DESCRIPTION OF THE PREFERRED EMBODIMENT

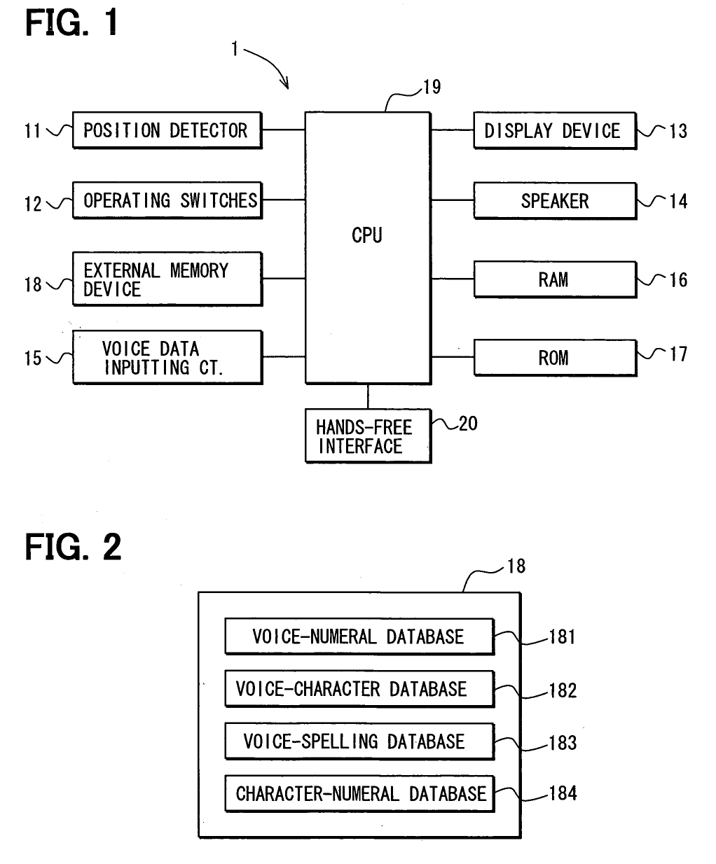

A preferred embodiment of the present invention will be described with reference to accompanying drawings. First, referring to FIG. 1, a navigation system 1 for use in an automotive vehicle, to which the present invention is applied, will be described. The navigation system 1 includes: a position detector 11; a group of operating switches 12, an image display device 13; a speaker 14; a voice data inputting circuit 15; a RAM 16; a ROM 17; an external memory device 18; a central processing unit (CPU) 19; and a hands-free interface 20.

The hands-free interface 20 is a device for realizing hands-free communication between a user and a mobile phone (not shown). The hands-free interface 20 is connected to the mobile phone either wirelessly or by wire. Signals from the mobile phone are converted into signals which are able to be handled in the CPU 19, and signals from the CPU 19 are converted into signals which are able to be handled in the mobile phone. The position detector 11 including a magnetic sensor, a gyroscope, a vehicle speed sensor and a GPS receiver (all of them are known devices and not shown in FIG. 1) detects a current position and a driving direction of the vehicle. Such data showing the vehicle position are fed to the CPU 19.

The group of operating switches 12 includes plural mechanical switches mounted on the navigation system 1 and touch panel switches overlapped on a display panel of the display device 13. Various signals are fed to the CPU 19 from the user by operating these switches 12. Images, such as a map showing an area around a current position of the vehicle, are displayed on the display panel of the display device 13 according to image signals sent from the CPU 19. User's voices are inputted into the voice inputting circuit 15 through a microphone (not shown), and voice data signals formed therein are fed to the CPU 19.

The external memory device 18 is a rewritable memory such as a HDD. A program to be carried out in the CPU 19, a map database for a route guidance, and other databases are stored in the external memory device 18. As shown in FIG. 2, the databases stored in the external memory device 18 include a voice-numeral database 181, a voice-character database 182, a voice-spelling database 183 and a character-numeral database 184.

The voice-numeral database 181 is the database showing one-to-one correspondence between a voice signal and a single numeral. For example, the database shows that a voice signal [wˆn] obtained by pronouncing “one” corresponds to a numeral “1”, [tu:] obtained by pronouncing “two” corresponds to a numeral “2”, and so on. In the same manner, one-digit numerals 0-9 are pared with the respective voice signals.

The voice-character database 182 is the database showing one-to-one correspondence between a voice signal and a single character. For example, the database shows that a voice signal [ei] obtained by pronouncing “A” corresponds to a character “A”, a voice signal [bi:] obtained by pronouncing “B” corresponds to a character “B”, and so on. In the same manner, all the alphabet A to Z are pared with the respective voice signals.

The voice-spelling database 183 is the database showing that a voice signal obtained by pronouncing a word (such as a facility name or a name of a place) corresponds to a series of characters (a spelling). For example, the database shows that a voice signal [leksˆs] obtained by pronouncing a word “LEXUS” corresponds to a series of characters (a spelling) LEXUS. In the same manner, a number of words including facility names and names of places are pared with respective spellings. Since a large number of words are included in the voice-spelling database 183, the size of the database 183 is larger than the databases 181 and 182.

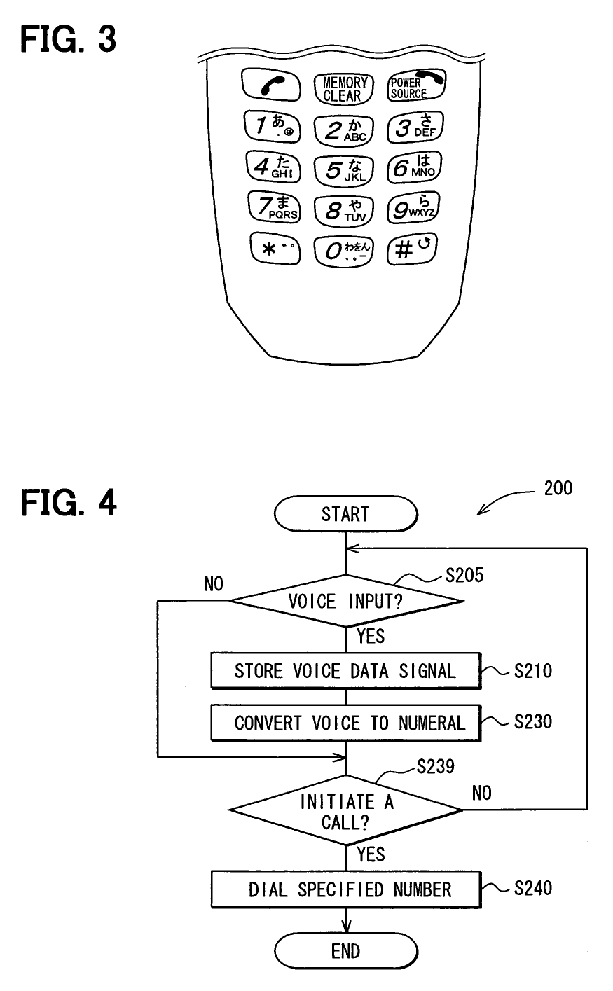

The character-numeral database 184 is the database showing correspondence between a group of a few characters and a numeral, the correspondence being the same as that in push buttons of a cell phone. As shown in FIG. 3, a group of three or four characters corresponds to a particular numeral. That is, ABC corresponds to “2”, DEF to “3”, GHI to “4”, JKL to “5”, MNO to “6”, PQRS to “7”, TUV to “8”, and WXYZ to “9”. Further, a group of period (.) and @ mark corresponds to a numeral “1”.

The CPU 19 operates the navigation system 1 according to a program stored in the ROM 17 and the external memory device 18. Data stored in the RAM 16, the ROM 17 and the external memory device 18 are read out, and new data are written in the RAM 16 and the external memory device 18. The CPU 19 communicates with the position detector 11, a group of operating switches 12, the display device 13, the speaker 14 and the voice data inputting circuit 15.

Processes performed by the CPU 19 include a process of searching a driving route, a process of guiding a driver and a process of operating hands-free interface. In the process of searching a driving route, a driving route from a present position to a destination is searched based on the stored map data when a driver inputs a destination via the operating switches 12. In the guiding process, a driving route searched is displayed on the display device 13, overlapping on the map. Instructions, such as directions to turn at an intersection, are given to the driver through the speaker 14. In the free-hands process, the on-board mobile phone is connected to a partner's phone (dialing up), partner's voice received by the on-board mobile phone is outputted from the speaker 14, and the user's voice is transmitted to the partner via the hands-free interface 20.

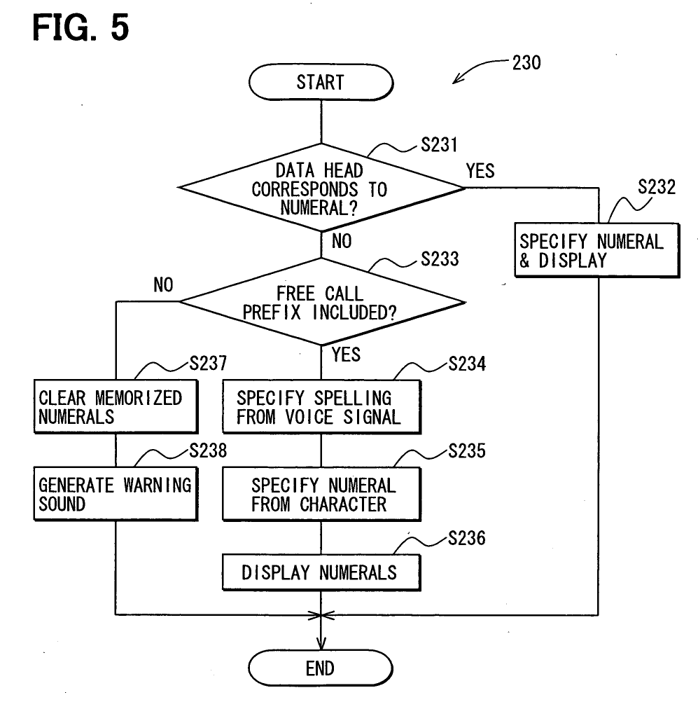

Now, referring to FIGS. 4 and 5, a process of converting voices to numerals performed by the CPU 19 will be described. This process 200 starts when a user inputs a command, such as starting a talk, via the switches 12. At step S205, whether a voice is inputted or not is determined by comparing an input voice level with a predetermined level. If the voice is inputted, the process proceeds to step S210, and if not, the process proceeds to step S239. At step S210, a voice signal unit inputted from the voice data inputting circuit 15 is stored in the RAM 16. The voice signal unit means a continuous voice input lasting for 0.1 second, for example.

At step S230, the inputted voice signals are converted into numerals, details of which will be explained later referring to FIG. 5. At step S239, whether a signal to initiate a call is inputted by the user via the switches 12 is determined. If the signal to initiate a call is inputted, the process proceeds to step S240, and if not, the process returns to step S205. At step S240, a series of numerals, i.e., a telephone number, specified at step S230 are fed to the on-board mobile phone to dial that number. As explained above, until a series of numerals composing a telephone number are all specified, the inputted voice signals are processed by each voice signal unit (unit by unit).

The step S230 for converting voices to numerals unit by unit will be explained in detail with reference to FIG. 5. At step S231, whether a top (beginning) of the voice signal unit corresponds to any one of the numerals (0-9) is determined. When a signal pattern of the voice signal unit coincides with a pattern of one of the numerals, in a known voice recognition method, at a probability higher than a predetermined level, it is determined that the voice signal unit corresponds to one of the numerals. If the voice signal unit corresponds to one of the numerals, the process proceeds to step S232, and if not, the process proceeds to step S233.

At step S232, a numeral corresponding to the voice signal unit is specified based on the voice-numeral database 181. The specified numeral is stored in the RAM 16 and displayed on the display device 13. If a numeral or a series of numerals have been already stored in the RAM 16, the numeral specified this time is added to the end of the already stored numeral or the series of numerals. The newly specified numeral is displayed on the display device 13 by adding it to the end of the already displayed numeral or numerals. Steps S231 and the S232 are carried out, unit by unit, for all voice signal units.

At step S233, whether a series of numerals currently stored in the RAM 16 includes a prefix number indicating a free call at a front portion of the series of numerals is determined. The free call number is, for example, 1-800 in the United States and 0120 in Japan. If the free call number is included, the process proceeds to step S234, and if not, the process proceeds to step S237. At step S234, a series of characters or a spelling of a word is specified from inputted voice signals as a whole (as a series of voice signal units) based on the voice-character database 182 and the voice-spelling database 183.

At step S235, a series of numerals is specified from the spelling specified at step S234 based on the character-numeral database 184. That is, the characters are converted into numerals character by character. The specified series of numerals is memorized in the RAM 16 by adding the newly specified series of numerals to the end of the free call prefix number stored in the RAM 16. At step S236, the newly specified series of numerals are added to the free call prefix number that has been displayed on the display device 13. Then, the process 230 comes to the end.

At step S237, all of the numerals stored in the RAM 16 and displayed on the display device 13 are cleared (canceled). At step S238, a warning (e.g., a beep sound) is outputted from the speaker 14. Then, the process 230 comes to the end.

As explained above, the inputted voice signals are converted into numerals unit by unit. If all the voice signals correspond to numerals, all the voice signals are converted into a series of numerals, i.e., a telephone number. If the voice signals representing numerals are followed by voice signals representing a word, and the specified numerals include a free call prefix number, the spelling of the word is specified based on the voice-spelling database. In this manner, an entire telephone number including a free call prefix number is specified from the inputted voice signals. If there is no free call prefix number is found before the voice signals representing a word are inputted, all the memory is reset and a warning is given to the user.

The process of converting voices to numerals will be further explained using an example, assuming that the free call prefix number is 1-800. A user starts the conversion process by pushing a talk switch, and inputs his/her voice “[wˆn]-[eitzirouzirou]-[pi:]-[si:]-[es]-[leks´s]”. A voice signal in each bracket [ ] represents a voice signal unit. The process 230 shown in FIG. 5 is carried out unit by unit.

First, from the voice signal unit [wˆn], numeral “1” is specified based on the voice-numeral database 181 and is stored in the RAM 16. Then, numerals “800” are specified from the voice signal unit [eitzirouzirou] and added to the numeral “1” stored in the RAM 16. Thus, a series of numerals “1800” showing a free call prefix number is stored in the RAM 16 and displayed on the display device 13. At this point, it is determined that the free call number is included (S233). Then, a numeral “7” is specified from the voice signal unit [pi:] based on the voice-character database 182 and the character-numeral database 184 showing a character group PQRS corresponds to a numeral “7”. Similarly, a numeral “2” is specified from the voice signal unit [si:], and a numeral “7” from the voice signal unit [es]. The newly specified numerals are added one by one to the already stored numerals and displayed.

Then, a spelling “LEXUS” is specified from the voice signal unit [leksˆs] based on the voice-spelling database 183. Finally, a series of numerals “53987” is specified from the spelling “LEXUS” based on the character-numeral database 184. The newly specified series of numerals “53987” are added to the numerals previously stored in the RAM 16 and displayed on the display device 13. Thus, an entire telephone number 180072753987 is obtained from the inputted voice signals. It is possible to limit the number of numerals following the free call prefix number to seven digits, for example. In this case, the last numeral “7” is eliminated as an excessive numeral. Upon permission of a call by the user, the telephone number 18007275398 is automatically dialed.

Advantages attained by the present invention are summarized below. A spelling of a word (such as a facility name or a name of a place) is specified from voice signals obtained from utterance of a speaker based on the voice-spelling database. A series of numerals is specified from the spelling of the word using the character-numeral database that shows correspondence between a group of a few characters and a numeral. Therefore, a bulky database that shows correspondence between a great number of words and a series of numerals is not necessary. Further, a series of numerals is specified from voice signals of a word (such as a facility name) only when the voice signals representing the word are inputted after numerals indicating a free call prefix number are found. In addition, the facilities offering the free call are not too many. Therefore, the number of words from which a series of numerals is specified is rather limited, and a size of the voice-spelling database can be reasonable.

The present invention is not limited to the embodiment described above, but it may be variously modified. For example, the character-numeral database 184 may be such a database that shows correspondence between a group of a few Japanese characters and a numeral. It is preferable, in this case, the correspondence between a group of a few Japanese characters between a numeral coincides with an arrangement of push buttons on a cell phone (or a mobile phone) shown in FIG. 3. That is, characters ( [symbol] , [symbol] , [symbol] , [symbol] , [symbol] ) corresponds to numeral “1”, characters ( [symbol] , [symbol] , [symbol] , [symbol] , [symbol] ) corresponds to numeral “2”, and so on.

It may not be necessary to specify characters from voice signals based on the voice-spelling database 183. The characters may be specified one by one based on the voice-character database 182, and then, the numerals may be specified from the characters based on the character-numeral database 184. The various databases stored in the external memory device 18 may be included in a program for the process of converting voices to numerals.

The device for converting voices to numerals according to the present invention may be applied to apparatus other than the navigation system. It may be applied to various hands-free apparatus or a cell phone. It may be used as a device in a call center that functions in the following manner. Communication between the call center and a first telephone is opened according to a call from the first telephone; the communication center automatically specifies a series of numerals (a telephone number of a second telephone) from voice signals from the first telephone; and communication between the first telephone and the second telephone is automatically opened using the specified telephone number. In this case, a circuit similar to the voice data inputting circuit 15 equipped in the call center receives the voice signals from the first telephone. The voice signals received from the first telephone are processed in a similar manner as in the processes shown in FIGS. 4 and 5. The specified numerals, however, are not shown on the display device but are notified to the first telephone user by voice communication.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A device for converting voices to numerals, comprising:
means for obtaining voice signals from utterance of a user;
a memory device for storing a voice-spelling database showing correspondence between the voice signals and a spelling of a word and a character-numeral database showing correspondence between a group of characters and a numeral; and
means for specifying a spelling of a word from the voice signals based on the voice-spelling database and for specifying a series of numerals from the specified spelling based on the character-numeral database.

2. The device for converting voices to numerals as in claim 1, further including means for initiating a telephone call using the series of numerals specified by the specifying means.

3. The device for converting voices to numerals as in claim 1, wherein:
the memory means further stores a voice-numeral database showing correspondence between the voice signals and numerals;
the specifying means first specify numerals from the voice signals based on the voice-numeral database, and then specifies a spelling of a word from the voice signals based on the voice-spelling database and a series of numerals from the specified spelling based on the character-numeral database, only when the specified numerals include a predetermined series of numerals.

4. The device for converting voices to numerals as in claim 3, wherein:
the predetermined series of numerals are prefix numerals indicating a free call telephone number.

5. A computer program, in which a spelling of a word is specified from voice signals taken from utterance of a user based on a voice-spelling database showing correspondence between voice signals and a spelling of a word, and in which a series of numerals is specified from the specified spelling based on a character-numeral database showing correspondence between a group of characters and a numeral.
